(19) United States
(12) Patent Application Publication
(10) Pub. No.: US 2024/0328095 A1
(43) Pub. Date: Oct. 3, 2024

(54) METHOD FOR PRODUCING AN ARTIFICIAL TURF

(71) Applicant: TARKETT SPORTS CANADA INC., Montreal (CA)

(72) Inventors: Jürgen Morton-Finger, Weinheim (DE); Ulrich Berghaus, Troisdorf (DE); Gregory T. Randall, Dalton, GA (US); Thomas Metz, Wald-Michelbach (DE)

(21) Appl. No.: 18/622,399

(22) Filed: Mar. 29, 2024

(30) Foreign Application Priority Data
Mar. 31, 2023 (EP) 23165936.8

(51) Int. Cl. E01C 13/08; D06N 7/00

(52) U.S. Cl. CPC E01C 13/08; D06N 7/0068; D06N 7/0076; D10B 2505/202

(57) ABSTRACT

A method for producing an artificial turf comprises providing a carrier material and a plurality of fibers, each fiber having ends extending from the top of the carrier material and having a connected region arranged in a loop-like manner at the bottom of the carrier material. The carrier material is fed with the fibers to a heated rotating calender roller and guided over at least one sub-region of the surface of the heated rotating calender roller, with the connected regions of the fibers and the bottom of the carrier material facing the calender roller. The method further includes, during the guiding step, transferring heat from the heated rotating calender roller to the carrier 10 material and the fibers, fusing the connected regions of the fibers with the bottom of the carrier material to form the artificial turf, and embossing the bottom of the artificial turf.

### CROSS-REFERENCE TO RELATED APPLICATION(S)

This application claims a benefit of priority under 35 U.S.C. § 119 (a) from European Patent Application Serial No. 23165936.8, filed Mar. 31, 2023, entitled “METHOD FOR PRODUCING AN ARTIFICIAL TURF,” which is hereby expressly incorporated by reference herein for all purposes.

### TECHNICAL FIELD

The present invention relates to an artificial turf as well as to a method for its production.

### BACKGROUND OF THE RELATED ART

A carpet having fluid barrier properties is known from U.S. Patent Application Publication No. US 2020/0223196 A1. The carpet comprises: (a) a greige good comprising: i) a primary backing material having a face surface and a back surface; ii) a plurality of fibers attached to the primary backing material, wherein a portion of the plurality of fibers extends from the face surface of the primary backing and wherein a second portion of the plurality of fibers are exposed on the back surface of the primary backing in a form of back stitches; b) an adhesive layer comprising a hot melt adhesive composition applied to the back surface of the primary backing material, wherein the adhesive composition is configured to substantially encapsulate at least a portion of the back stitches; and c) a laminated film having fluid barrier properties.

A method for producing an artificial turf is known from EP 20 192 846.2 and WO 2022/043231, which method comprises the following steps: Providing a carrier material having a top and a bottom, providing a plurality of fibers, wherein each fiber comprises two ends extending from the top of the carrier material and comprises a connected region arranged in a loop-like manner at the bottom of the carrier material; feeding the carrier material with the fibers to a heated rotating calender roller; guiding the carrier material with the fibers over at least one sub-region of the surface of the heated rotating calender roller, wherein the connected regions of the fibers and the bottom of the carrier material face the calender roller; during the guiding of the carrier material with the fibers over the at least one sub-region of the surface of the heated rotating calender roller: transferring heat from the heated rotating calender roller to the carrier material with the fibers, and fusing the connected regions of the fibers with the bottom of the carrier material to the artificial turf, and removing and cooling the artificial turf.

In conventional plastic artificial turfs, deformations of the artificial turf may arise at high temperatures. These deformations are typically substantially reversible. Such deformations can for example already arise at artificial turf temperatures of 35° C. or higher, and substantially reduce again at lower temperatures. However, in particular at high ambient temperatures, for example in the case of direct sunlight, an artificial turf can heat up substantially more, for example to temperatures of 50° C., 60° C., 70° C., 80° C. or higher. The deformations are typically more pronounced at higher temperatures.

In particular, artificial turf that contains recycled material (for example, old artificial turf, also called “end-of-life (EOL) turf”) as a secondary raw good or secondary material, can have an increased stiffness compared with conventional artificial turf without recycled material, and be particularly susceptible to deformations.

Deformations of the artificial turf such as wave formation can influence the functionality of the artificial turf and are therefore considered to be disadvantageous. For example, deformations frequently change characteristic properties of the artificial turf. However, in general it is sought that the characteristic properties of an artificial turf should not change under different conditions, such as different temperatures. The unevenness of a deformed artificial turf can lead for example to changed bouncing and rolling behavior of a ball. Furthermore, frequent deformation of the artificial turf can lead to quicker material fatigue and a shorter life cycle of the artificial turf.

In the artificial turf described in EP 20 192 846.2 and WO 2022/043231, fibers can be arranged on the carrier material either individually or in bundles. In the method described there, rows form on the bottom of the artificial turf, i.e., raised regions, due to the fusing together of adjacent fiber bundles or adjacent fibers. The raised regions extend along the bottom of the artificial turf, over a length which is longer than an average distance between two adjacent fiber bundles or two adjacent fibers. The rows are described in FIGS. 5B-5C of EP 20 192 846.2 and FIGS. 10B-10C of WO 2022/043231, and the associated passages of the description.

In the artificial turfs of EP 20 192 846.2 and WO 2022/043231, deformations of the artificial turf can also arise at temperatures of 35° C. or higher on account of the rows on the bottom of the artificial turf, i.e., the raised regions. The temperature increase, for example to a temperature in the region of over 35° C., generally leads to an expansion of the material of the artificial turf. However, expansion of the material of the rows is not possible in the row direction, and therefore shifting can occur which can lead to formation of undulations.

A problem addressed by the present invention is therefore that of providing a method for producing an artificial turf having good heat resistance, i.e., dimensional stability even at high temperatures of the artificial turf, for example at temperatures in the range of 35° C.-80° C., by means of which method the high-quality artificial turf can be produced. A further problem addressed by the present invention is that of providing an artificial turf having a high quality and heat resistance, and produced by the method according to the invention.

### SUMMARY

This problem is solved according to the invention by a method for producing an artificial turf and by an artificial turf according to the independent claims. Preferred embodiments of the invention are described in the dependent claims.

The method according to the invention comprises the following steps: providing a carrier material having a top and a bottom; providing a plurality of fibers, wherein each fiber comprises two ends extending from the top of the carrier material and comprises a connected region arranged in a loop-like manner at the bottom of the carrier material; feeding the carrier material with the fibers to a heated rotating calender roller; guiding the carrier material with the fibers over at least one sub-region of the surface of the heated rotating calender roller, wherein the connected regions of the fibers and the bottom of the carrier material face the calender roller; during the guiding of the carrier material with the fibers over the at least one sub-region of the surface of the heated rotating calender roller: transferring heat from the heated rotating calender roller to the carrier material with the fibers, and fusing the connected regions of the fibers with the bottom of the carrier material to the artificial turf; wherein the method further comprises embossing a bottom of the artificial turf, wherein the embossing forms a recessed region or a plurality of recessed regions of the bottom of the artificial turf; and removing and cooling the artificial turf.

Comments relating to a recessed region can be applied analogously to a plurality of recessed regions, and vice versa.

The terms “bottom” and “top” can relate to a bottom and a top when the artificial turf is arranged as intended, i.e., for example is located on a plane, wherein free ends of the fibers point upwards, and connected regions of the fibers point downwards.

Forming a recessed region can mean that the region is recessed, after embossing, relative to the corresponding region of the artificial turf before embossing. It is possible that the artificial turf may not be broken through on the recessed region, i.e., it is possible that the artificial turf may not have any interruption and/or any aperture and/or any opening and/or any hole on the recessed region, for example. Rather, the surface of the recessed region is recessed, i.e., for example retracted. In other words: The surface of the artificial turf may be uninterrupted in the recessed region. Embossing recessed regions can have the advantage of retaining the structural integrity of the surface of an artificial turf bottom, which can enable good structural strength of the artificial turf.

The step of embossing a bottom of the artificial turf can take place during the step of fusing the connected regions of the fibers with the bottom of the carrier material, to form the artificial turf.

The step of embossing a bottom of the artificial turf can take place after the step of fusing the connected regions of the fibers with the bottom of the carrier material, to form the artificial turf.

In the method according to the invention, embossing of the bottom of the artificial turf enables good heat resistance, i.e., dimensional stability upon heating. This is achieved in that the embossing forms one or more recessed regions of the bottom of the artificial turf. The recessed region functions as a free intermediate space, into which the material of the artificial turf can expand upon heating, such that the free intermediate space reduces in size or closes upon heating. Thus, material shifts during heating, which would result without the free intermediate space, are prevented or reduced. Thus, distortions and/or formation of undulations of the artificial turf upon heating are prevented or reduced.

In the method according to the invention, the cohesion between the fibers and the carrier material is achieved in that the fibers are fused directly with the carrier material, at the connected regions of the fibers. In this way, in particular a simple, compact and stable design of the artificial turf is ensured, and in particular no additional film is required in order to connect the fibers to the carrier material. Furthermore, as a result the material consumption can be reduced and the recyclability of the artificial turf can be increased, since the artificial turf contains fewer individual components and the connection between the fibers and carrier material is established without additional components. Since merely the carrier material with the plurality of fibers has to be guided over the calender roller and fused, the complexity of the method, and the process time, are also reduced.

In a preferred embodiment, the bottom of the artificial turf has a main plane, wherein the main plane of the bottom of the artificial turf is a plane which contains one or more surface regions of the bottom of the artificial turf, for example before embossing or after embossing, wherein the one or more surface regions which are contained in the main plane have a total surface area which is at least 20%, at least 30%, at least 40%, at least 50%, at least 60%, at least 70%, at least 80%, at least 90%, or 100% of the total surface area of the bottom of the artificial turf, and wherein the recessed region is preferably recessed relative to the main plane of the bottom of the artificial turf.

The fact that a region on the bottom of the artificial turf is recessed relative to a main plane of the bottom and/or to the not yet embossed bottom can mean that said region is recessed in the direction of the top of the artificial turf, i.e., recessed “upwards”.

A main plane of a bottom of the artificial turf can be defined by the bottom before embossing. In other words: The main plane can be a plane that comprises one or more surface regions of the non-embossed bottom of the artificial turf or one or more surface regions of the bottom of the artificial turf before embossing. The term “non-embossed bottom” can mean “bottom that is not yet embossed” or “bottom that is not embossed”.

The fact that the main plane contains a surface region can mean that the surface region is located in the main plane. Surfaces, for example a bottom of the artificial turf, which have a main plane are also referred to in the following as substantially flat. Surfaces in which at least 90% of the surface, for example 100% of the surface, is located in the main plane are also referred to in the following as flat. The fact that the recessed region is recessed can mean that the recessed region is recessed from the main plane in the direction of the top of the artificial turf, i.e., upwards.

For example, at least 1%, at least 5%, at least 10%, at least 20%, at least 25%, at least 30%, at least 40%, at least 50%, at least 60%, at least 70%, at least 80% or at least 90% of the surface of the bottom of the artificial turf can be recessed relative to the main plane of the bottom and/or relative to the not yet embossed bottom. For example at least 1%, at least 5%, at least 10%, at least 20%, at least 25%, at least 30%, at least 40%, at least 50%, at least 60%, at least 70%, at least 80% or at least 90% of a surface area of a projection of the surface of the bottom of the artificial turf can be recessed relative to the main plane of the bottom and/or relative to the not yet embossed bottom, wherein the projection is a projection in a perpendicular direction relative to the main plane, i.e., the surface without taking into account vertical surface regions which result from the embossing, i.e., for example side walls of recessed regions.

Regions of the main plane or the not yet embossed bottom, in which regions of the surface of the bottom of the artificial turf are recessed after embossing, can contain a total surface area of for example at least 1%, at least 5%, at least 10%, at least 20%, at least 25%, at least 30%, at least 40%, at least 50%, at least 60%, at least 70%, at least 80% or at least 90% of the surface area of the main plane.

A region of the main plane or of the not yet embossed bottom, which corresponds to a single recessed region, can for example have a surface area of at most 1 cm², or at most 0.5 cm², or at most 0.1 cm². A region of the main plane or of the not yet embossed bottom, which corresponds to at least single recessed region, can for example have a surface area of at least 1 cm², or at least 5 cm², or at least 10 cm². A region of the main plane or of the not yet embossed bottom, which corresponds to a single recessed region, can for example have a surface area which corresponds to the average distance, for example in the longitudinal direction, of two fibers/fiber bundles that are adjacent to one another, for example in the longitudinal direction, or a particular multiple thereof. For example, a region of the main plane or of the not yet embossed bottom, which corresponds to a single recessed region, can have a surface area which corresponds to at most 5 times the square of the average distance, for example in the longitudinal direction, of two fibers/fiber bundles that are adjacent to one another, for example in the longitudinal direction, at most 3 times, at most twice, at most 1.5 times, at most once, at least 0.5 times, or at least 0.1 times. A region of the main plane or of the not yet embossed bottom, which corresponds to a single recessed region, can have a length and/or a width of at least 5 cm, at most 2 cm, at most 1 cm, or at most 0.5 cm. A region of the main plane or of the not yet embossed bottom, which corresponds to a single recessed region, can have a length and/or a width of at least 0.5 cm, at least 1 cm, or at least 2 cm.

The longitudinal direction can denote a direction in which the artificial turf is unrolled and/or in which the carrier material, with the fibers, is guided over the calender roller.

A region of the main plane that corresponds to a single recessed region can be in the shape of polygons, for example trigons, tetragons, pentagons, hexagons, heptagons. A region of the main plane that corresponds to a single recessed region can be in the shape of triangles, rectangles, circles or ellipses. A region of the main plane that corresponds to a single recessed region can be in the shape of crosses or stars. The fact that a region of the main plane that corresponds to a single recessed region is in a certain shape can mean that the recessed region is also in this shape.

Cross-shaped and/or star-shaped recessed regions can be particularly preferred, because they have a large edge surface in relation to the overall surface area, on which edge surface the material of the artificial turf can extend. In this way, such shapes of recessed regions can enable particularly good heat resistance.

The recessed region can have a groove shape, i.e., for example be of a length that is substantially larger than a width, i.e., for example the shape of an elongate recessed rectangle. A groove-shaped recessed region can be of a length which exceeds the average distance, for example in the longitudinal direction, of two fiber bundles which are adjacent to one another, for example in the longitudinal direction, for example is at least five times an average distance, at least ten times, at least fifty times, at least one hundred times, or at least one thousand times. The length of the recessed region can be at least twice a width of the recessed region, at least five times, at least ten times, at least fifty times, at least one hundred times, or at least one thousand times said width. For example, the recessed region in the form of a groove can extend along the bottom of the artificial turf, i.e., for example from one edge of the bottom of the artificial turf to an opposite edge. The recessed region can be of a length that is at least 50%, at least 70% or at least 90% of a side length of a sheet of the artificial turf. The recessed region can be embossed in a longitudinal direction and/or in a transverse direction and/or in an oblique direction relative to the longitudinal and to the transverse direction. Transverse can denote a direction which is at right-angles to a longitudinal direction. Oblique can denote a direction which is at an angle, relative to another direction, which is greater than 0° and smaller than 90°, for example between 15° and 75°, or between 30° and 60°.

Recessed regions in the form of grooves can be formed in parallel with one another, and/or obliquely and/or at right-angles to one another, i.e., for example in the form of a lattice.

Embossing the recessed regions in the form of grooves can have the advantage of being particularly easy to achieve in technical terms, i.e., for example with reduced complexity and/or reduced outlay and/or reduced wear of an embossing unit.

The recessed region and/or the recessed regions can have a sawtooth pattern and/or a zigzag pattern in a cross section in a plane which is at right-angles to a plane of the surface of the bottom of the artificial turf, for example at right-angles to the main plane. The recessed region and/or the recessed regions can be in the shape of pyramids, for example of pyramids having a square base surface. For example, the entire surface of the bottom of the artificial turf can be made up of recessed regions which are in the shape of pyramids.

The shape of the recessed region 40 can be based on the shape of the embossing unit.

For example, at least 1%, at least 5%, at least 10%, at least 20%, at least 25%, at least 30%, at least 40%, at least 50%, at least 60%, at least 70%, at least 80% or at least 90% of the surface of the bottom of the artificial turf can be recessed relative to the main plane of the bottom and/or relative to the not yet embossed bottom.

A plurality of recessed regions can be at a predetermined distance from one another, for example the plurality of recessed regions can be uniformly distributed. For example, the average distance between two adjacent recessed regions, which each have a groove shape for example, can correspond to an average width of the recessed regions in the direction of the shortest distance between the adjacent regions, or a multiple thereof, for example at most 10 times, at most 5 times, at most twice, at most once, at least once, at least 0.75 times, at least 0.5 times. For example, the recessed regions can form a grid, i.e., a pattern that is distributed uniformly on a surface. For example, the recessed regions can be at an average distance from one another of at most 0.5 cm, at most 1 cm, at most 2 cm, or at most 5 cm.

If the recessed regions are embossed uniformly or with a predetermined distance from one another, this can enable uniform heat resistance of the artificial turf.

The recessed region can for example also be in the form of a lattice.

In a preferred embodiment, the artificial turf contains a raised region on its bottom, wherein the raised region has a height downwards from a plane, wherein the plane, for example a main plane of the bottom of the artificial turf, contains one or more surface regions of the bottom of the artificial turf, for example the non-embossed bottom, wherein the raised regions extend in a length along a direction on the bottom of the artificial turf; wherein the length is greater than the average distance, for example in the longitudinal direction, between two fibers that are adjacent to one another, for example in the longitudinal direction, or two adjacent fiber bundles; and wherein the embossing reduces the height of the raised region from the plane in portions and/or interrupts the raised region in portions.

The artificial turf can also contain a plurality of raised regions on its bottom. Comments relating to a raised region can be applied analogously to a plurality of raised regions, and vice versa.

The direction “downwards” proceeding from a plane that contains one or more surface regions of a bottom of the artificial turf can mean “outwards from the bottom of the artificial turf”, or “outwards from the bottom of the artificial turf and perpendicular to the plane”.

The direction “upwards” proceeding from a plane that contains one or more surface regions of a bottom of the artificial turf can mean “from the bottom of the artificial turf in the direction of a top”, or “from the bottom of the artificial turf in the direction of a top and perpendicular to the plane”.

The raised region can for example be formed by fusing together adjacent fibers or adjacent fiber bundles. The raised region can be formed for example by/during fusing of connected regions of the fibers with the bottom of the carrier material. The raised region can contain fusion regions of adjacent, different fibers/fiber bundles.

For example, one or more raised regions can extend in rows or in other patterns or in a grid along the bottom of the artificial turf, i.e., for example from one edge of the bottom of the artificial turf to an opposite edge. The raised region can be of a length that is at least 50%, at least 70% or at least 90% of a side length of a sheet of the artificial turf. Raised regions can be protruding regions which protrude from the plane of the bottom of the artificial turf by the height.

The raised region can have a rib shape, i.e., for example be of a length that is substantially larger than a width, i.e., for example the shape of an elongate raised rectangle. A rib-shaped raised region can be of a length which exceeds the average distance, for example in the longitudinal direction, of two fiber bundles which are adjacent to one another, for example in the longitudinal direction, for example is at least five times an average distance, at least ten times, at least fifty times, at least one hundred times, or at least one thousand times. The length of the raised region can be at least twice, at least 5 times, at least 10 times, at least 50 times, at least 100 times, or at least 1000 times a width of the raised region. For example, the raised region in the form of a rib can extend along the bottom of the artificial turf, i.e., for example from one edge of the bottom of the artificial turf to an opposite edge. The raised region can be of a length that is at least 50%, at least 70% or at least 90% of a side length of a sheet of the artificial turf. The raised region can extend in a longitudinal direction and/or in a transverse direction and/or in an oblique direction.

A rib shape can be an inverted groove shape, and therefore disclosures with respect to a groove shape can be applied correspondingly to a rib shape, and vice versa.

Raised regions can have a positive effect on the pull-out strength of the fibers or fiber bundles, for example if the raised regions contain fusion regions of adjacent fibers or fiber bundles.

Reducing the height can mean that the raised regions are also raised in the portion of reduced height, i.e., are still raised after embossing. This makes it possible for the raised regions of reduced height to still have a positive effect on the pull-out strength of the fibers. At the same time, the embossing forms free intermediate spaces, into which the material of the artificial turf can expand upon heating, and thus enables improved heat resistance.

The reduced height can for example be in the range of 10%-90% of the height of the raised regions, the height of which is not reduced, preferably in the range of 25%-75%, more preferably in the range of 40%-60%. The reduced height can for example be reduced by 1 cm or less relative to the non-reduced height, or by 0.5 cm or less, or by 0.2 cm or less, or by 0.1 cm or less. The non-reduced height of the raised region can for example be 1 cm or less, or 0.5 cm or less, or 0.2 cm or less, or 0.1 cm or less.

The fact that the height is reduced or interrupted in portions means that the height of one portion or a plurality of portions of the raised region is reduced, i.e., that the reduction of the height is spatially limited. The term “portions” can denote regions.

The total surface area of embossed portions/recessed regions of a raised region can for example be in the range of 10%-90% of the total surface area of the raised region before embossing, preferably in the range of 25%-75%, more preferably in the range of 40%-60%. The width and/or length of a single embossed portion/recessed region of the raised regions can for example be at most 5 cm, at most 2 cm, at most 1 cm, or at most 0.5 cm. The width and/or length of a single embossed portion/recessed region of the raised regions can for example be at least 0.5 cm, at least 1 cm, at least 2 cm, or at least 5 cm.

Since the height is reduced in portions, one or more intermediate spaces are formed in the portion(s) or region(s) of reduced height, into which intermediate spaces the material of the artificial turf can expand upon heating.

In a preferred embodiment, the embossing interrupts the raised regions in portions, i.e., the regions are no longer raised, i.e., their height is reduced by 100%, in the interrupted/embossed region. Interrupting a raised region means that one raised region is divided into a plurality of raised regions. This can form particularly deep free intermediate spaces, into which the material of the artificial turf can expand upon heating, and thus enable particularly good heat resistance of the artificial turf.

In a preferred embodiment, a plurality of groove-shaped recessed regions is embossed obliquely to a plurality of raised regions, which are each in the form of a rib, wherein the recessed regions in each case extend in a first direction, and the raised regions in each case extend in a second direction, wherein the first direction and the second direction are oblique to one another, preferably approximately at right angles, i.e., at an angle of 40%-50% to one another, wherein the average distance of the recessed regions from one another is in the range of 0.5 times to 1.5 times the average distance of the raised regions from one another. For example, the recessed regions can then reduce a height of the raised region in portions and/or interrupt the raised regions in portions.

In a preferred embodiment, a plurality of recessed regions, which are each groove-shaped and are preferably in parallel with one another, interrupt a plurality of raised regions which are each in the form of a rib.

Reducing the height of the raised region in portions can also mean that the height in the portion becomes negative, i.e., that a recessed region is formed from a raised region, in the portion. This can be understood to mean that the height is reduced by more than 100%, i.e., becomes negative. This can form particularly deep free intermediate spaces, into which the material of the artificial turf can expand upon heating, and thus enable particularly good heat resistance of the artificial turf.

The embossing can form a recessed region in a raised region of the bottom of the artificial turf, and can form a recessed region in a surface region of the bottom of the artificial turf, wherein the raised region has a height downwards from the surface region. The surface region can be contained in the main plane. The surface region can also not be raised.

Embossing a raised and a non-raised region together can simultaneously enable good heat resistance and good pull-out strength.

In a preferred embodiment, a maximum height of shifts of the carrier material of the artificial turf on the top of the artificial turf at a predetermined temperature of the artificial turf is less than 2 cm, preferably less than 1 cm, more preferably less than 0.5 cm, even more preferably less than 0.1 cm, wherein the predetermined temperature is at least 35° C., or at least 40° C., or at least 50° C., or at least 60° C., or at least 70° C., or at least 80° C., wherein the height is a height of a flat surface region of the top of the carrier material of the artificial turf, and/or of a flat surface region of the top of the artificial turf, for example from a main plane of the top of the carrier material of the artificial turf, wherein shifts include surface regions of the top of the carrier material of the artificial turf which are raised relative to a flat surface region of the top of the carrier material.

The height can be a height perpendicular to a plane of the artificial turf.

Artificial turfs in which a maximum height of shifts at one of the specified temperatures is in one of the specified height ranges can have good heat resistance, i.e., dimensional stability at high temperatures, and good stability of characteristic properties even at high temperatures.

In a preferred embodiment, the calender roller contains an embossing unit, and the bottom of the artificial turf is embossed by means of the embossing unit of the calender roller.

This offers the advantage that the embossing can be achieved with little outlay, in that the function of the transfer of heat and the embossing can both be performed by the calender roller. For example, renewed heating of the artificial turf is not required for the embossing, which enables an energy-efficient method. The calender roller is heated, as a result of which the embossing can be carried out efficiently.

In a preferred embodiment, the artificial turf is cooled by means of a cooling roller, wherein the artificial turf is fed to the cooling roller, wherein the cooling roller contains an embossing unit, and the bottom of the artificial turf is embossed by means of the embossing unit of the cooling roller.

This embodiment also offers the advantage that the embossing can be achieved with little outlay, in that the function of the cooling and the embossing can both be performed by the cooling roller.

In a preferred embodiment, the method further comprises: Feeding the artificial turf to an embossing roller which comprises an embossing unit, wherein the bottom of the artificial turf is embossed by means of the embossing unit of the embossing roller, wherein prior to the embossing heat is transferred to the artificial turf, and/or wherein the bottom of the artificial turf is embossed prior to removal and cooling of the artificial turf.

Embossing by means of a separate embossing roller enables increased flexibility in the setting of embossing parameters, such that properties of the recessed regions and thus of the artificial turf can be selected more freely.

Preferably, in the step of guiding, at least one rotating pressure roller is spaced apart by a calender gap and is arranged substantially axis-parallel to the calender roller, wherein the pressure roller presses the carrier material with the fibers against the heated rotating calender roller with a predetermined pressing force.

The at least one pressure roller arranged about the calender roller guides the carrier material with the fibers in a predetermined position over at least a sub-region of the surface of the heated rotating calender roller, whereby the process accuracy can be increased and the carrier material with the fibers is prevented from slipping. As a result, particularly good, i.e., uniform, fusing of the back of the carrier material with the connected regions of the fibers can be achieved. Further, by adjusting the calender gap, the pressing force on the carrier material with the fibers can be adjusted, as a result of which the process accuracy can be further improved and the connection between the carrier material and the fibers is strengthened. Moreover, the contact pressure of the pressure rollers accelerates the fusing between the fibers and the carrier material, as a result of which similar strength values can be achieved with shorter dwell times on the calender roller, and thus the process time can be reduced.

In a preferred embodiment, the method according to the invention further comprises a step of providing a film, wherein, in the step of feeding the carrier material, the film is fed between the bottom of the carrier material with the connected regions of the fibers and the heated rotating calender roller, and wherein, in the step of transferring heat, the film is fused to the bottom of the carrier material and to the connected regions of the fibers.

Locally, the film is fused both to the bottom of the carrier material and also to the connected regions of the fibers. As a result, the connection between the carrier material and fibers is strengthened, and thus the pull-out strength of the fibers is also increased. Globally, i.e., viewed over the entire artificial turf, the film provides the artificial turf with additional stability. “Stability” is understood to mean in particular the tensile strength and elongation (determined in a pulling test), the thermal stability (determined in a shrinkage test), as well as stability in the laying of artificial turf sheets, in particular against warping and folding of the artificial turf in a broad ambient temperature range.

In a further preferred embodiment, the method according to the invention comprises a step of providing a film, wherein, after the step of removing and cooling the artificial turf, the film is fed between a bottom of the artificial turf and a further heated rotating calender roller, a step of transmitting heat from the further heated rotating calender roller to the bottom of the artificial turf and the film, a step of fusing the bottom of the artificial turf to the film to form a coated artificial turf, and the steps of removing and cooling the coated artificial turf.

In this case, the film is not already fused to the bottom of the carrier material and to the connected regions of the fibers during the step of transmitting heat. Instead, the artificial turf is fed from the heated rotating calender roller to a further heated rotating calender roller, wherein the film is fused to the bottom of the artificial turf. As a result, the connection between the carrier material and fibers is further strengthened, and thus the pull-out strength of the fibers is also increased. Viewed over the entire artificial turf, the film provides the artificial turf with additional stability. Furthermore, using a further heated rotating calender roller simplifies the process control and the setting of the process parameters (e.g., temperature of the calender rollers, contact pressure, dwell time, etc.)

for the production of the artificial turf, since the process parameters for the further heated rotating calender roller can be selected separately and specially for melting on the film.

In a preferred embodiment, the material of the film comprises at least one of the following materials: ethylene-vinyl acetate, a thermoplastic elastomer, and a thermoplastic olefin. The mass fraction of ethylene-vinyl acetate, thermoplastic elastomers and thermoplastic olefins makes up, in total, at least 50% of the mass of the film, preferably at least 60%, 70% or 80%, more preferably at least 90%, or at least 95%.

Ethylene-vinyl acetate, thermoplastic elastomers, and thermoplastic olefins have a high elasticity. If regions of the artificial turf, for example the carrier material and/or connected regions of the fibers, expand, for example on account of heating, the material of the film can be compressed, such that shifts of the bottom of the artificial turf are prevented and/or reduced. In this way, heat resistance of the artificial turf can be improved.

For example, the film or the material of the film can be provided in regions between connected regions of the fibers, on the bottom of the carrier material.

The film can have a thickness of 1 mm or less, 0.5 mm or less, 0.2 mm or less, or 0.1 mm or less. A thin film may be preferred with a view to efficient use of resources. A thicker film may enable better mechanical stability.

The embossing of a bottom of the artificial turf can be carried out before the fusing of the film to the bottom of the carrier material and to the connected regions of the fibers, i.e., the artificial turf can be embossed before a film has been fused to the artificial turf.

This offers the advantage that the film or material of the film can be provided even in a recessed region.

The embossing of a bottom of the artificial turf can be carried out after the fusing of the film to the bottom of the carrier material and to the connected regions of the fibers, i.e., the artificial turf can be embossed after a film has been fused to the artificial turf.

The embossing of a bottom of the artificial turf can be carried out when fusing/during the fusing of the film to the bottom of the carrier material and to the connected regions of the fibers, i.e., the artificial turf can be embossed while a film is being fused to the artificial turf.

The step of providing a film preferably comprises spreading plastic granules on a conveyor belt, conveying the plastic granules by means of the conveyor belt to a heat input region, introducing heat and melting the plastic granules, conveying the molten plastic granules to a pressure input region, introducing pressure and compressing the molten plastic granules to form a film of a predetermined thickness, and removing and cooling the film.

In this case, the starting material is plastic granules, which enables better handling, for example, during transport and storage than in the case of a prefabricated film. Since the production of the film is integrated in a method according to the invention, the properties of the film (for example the strength, film thickness, etc.) can be flexibly adjusted to the requirements placed on the artificial turf, by a suitable selection of for example the amount of plastic granules, the chemical composition of the plastic granules, and by the amount and the duration of the heat input and the pressure input. Moreover, the integration of the film production into the method for producing an artificial turf makes it possible to not have to interrupt the production process, in order to change a film for example, since merely plastic granules have to be topped up, and the film can thus be produced continuously.

According to a further aspect, the method according to the invention comprises providing plastic granules, wherein, in the step of feeding the carrier material, the plastic granules are fed between the bottom of the carrier material with the connected regions of the fibers and the heated rotating calender roller, and wherein, in the step of transferring heat, the plastic granules are fused to the bottom of the carrier material and to the connected regions of the fibers.

In this case, the starting material is plastic granules, which enables better handling, for example, during transport and storage than in the case of a prefabricated film. In particular, the plastic granules can be easily fed in, in that they are spread onto the bottom of the carrier material with the connected fibers. Locally, the plastic granules are fused both to the bottom of the carrier material and also to the connected regions of the fibers, by the calender roller. As a result, the connection between the carrier material and fibers is strengthened, and thus the pull-out strength of the fibers is also increased. Globally, i.e., viewed over the entire artificial turf, the melted-on plastic granules provide the artificial turf with additional stability. Feeding a film, which requires additional process steps and the setting and monitoring thereof, is not required here. Thus, problems which may arise when feeding a film (process accuracy, tearing of the film, etc.) can be prevented, and the method is simplified overall. Furthermore, the properties of the artificial turf (strength, artificial turf height, etc.) can be flexibly adjusted by the amount of plastic granules, the chemical composition of the plastic granules, the amount and the duration of the heat input, and the pressure application by the calender roller or the pressure rollers.

According to a further aspect, the method according to the invention further comprises providing plastic granules, wherein, after the step of removing and cooling the artificial turf, the plastic granules are fed between a bottom of the artificial turf and a further heated calender roller, transmitting heat from the further heated rotating calender roller to the bottom of the artificial turf and the plastic granules, fusing the bottom of the artificial turf to the plastic granules to form a coated artificial turf, and removing and cooling the coated artificial turf.

In this case, the starting material is plastic granules, which enables better handling, for example, during transport and storage than in the case of a prefabricated film. In particular, the plastic granules can be easily fed in, in that they are spread onto the bottom of the carrier material with the connected fibers. In this case, the plastic granules are not already fused to the bottom of the carrier material and to the connected regions of the fibers during the step of transmitting heat. Instead, the artificial turf is fed from the heated rotating calender roller to a further heated rotating calender roller, wherein the plastic granules are fused to the bottom of the artificial turf and form a coating. As a result, the connection between the carrier material and fibers is further strengthened, and thus the pull-out strength of the fibers is also increased. Viewed over the entire artificial turf, the coating resulting from the melting on provides the artificial turf with additional stability. Furthermore, using a further heated rotating calender roller simplifies the process control and the setting of the process parameters (e.g., temperature of the calender rollers, contact pressure, dwell time, etc.) for the production of the artificial turf, since the process parameters for the further heated rotating calender roller can be selected separately and specially for melting on the plastic granules. Feeding a film, which requires additional process steps and the setting and monitoring thereof, is not required here. Thus, problems which may arise when feeding a film (process accuracy, tearing of the film, etc.) can be prevented, and the method is simplified overall. Furthermore, the properties of the coating (strength, coating thickness, etc.) can be flexibly adjusted to the requirements placed on the coated artificial turf, by the amount of plastic granules, the chemical composition of the plastic granules the amount and the duration of the heat input, and the pressure application by the calender roller or the pressure rollers.

According to one aspect of the present invention, in the step of guiding, at least one rotating pressure roller is spaced apart by a calender gap and is arranged substantially axis-parallel to the calender roller and/or the further calender roller, wherein the pressure roller presses the carrier material with the fibers and the film or the plastic granules against the heated rotating calender roller and/or the further heated calender roller with a predetermined pressing force.

The at least one pressure roller arranged about the calender roller and/or about the further calender roller guides the carrier material with the fibers and the film or the plastic granules, or the artificial turf and the film or the plastic granules, in a predetermined position over at least a sub-region of the surface of the heated rotating calender roller and/or over at least a sub-region of the surface of the further heated rotating calender roller, whereby the process accuracy can be increased and the carrier material with the fibers and the film or the plastic granules, or the artificial turf and the film or the plastic granules, is prevented from slipping. Further, by adjusting the calender gap, the pressing force on the carrier material with the fibers and the film or the plastic granules, or on the artificial turf and the film or the plastic granules, can be adjusted, thereby further improving the process accuracy and strengthening the connection between the carrier material, the fibers, and the film or the coating.

According to the present invention, it is further preferred that the carrier material and the film or the plastic granules be formed from substantially the same type of material.

The use of only one type of material for the carrier material and the film or the plastic granules improves the recyclability of the artificial turf, because no other materials, such as latex, polyurethane, etc., need to be separated from it. Moreover, this simplifies the process management and setting of the process parameters for the production of the artificial turf, because, due to the use of similar materials for the carrier material and the film or the plastic granules, their melting points are also similar, for example.

Preferably, the carrier material and the fibers are formed from substantially the same type of material.

The use of only one type of material for the carrier material and the fibers improves the recyclability of the artificial turf, because no other materials, such as latex, polyurethane, etc., need to be separated from it. Moreover, this simplifies the process management and setting of the process parameters for the production of the artificial turf, because, due to the use of similar materials for the carrier material and the fibers, their melting points are also similar, for example.

In a further preferred embodiment according to the present invention, the carrier material comprises recycled and recyclable material and/or the fibers comprise recycled and recyclable material.

The use of recycled or recyclable material for the carrier material and/or the fibers further improves the environmental footprint of the artificial turf (in particular, this can save a high degree of material consumption, energy, and CO2 emissions). Moreover, by using recycled material for the carrier material and/or the fibers, the production costs for the artificial turf can be reduced, because, instead of new material, recycled material, for example from old artificial turf, can be reused. Further, only the use of recyclable material allows for the recycling of the artificial turf after the end of the service life and thus its re-entry into the material cycle.

According to the present invention, the film or the plastic granules can comprise recycled and/or recyclable material.

The use of recycled or recyclable material for the film or the plastic granules further improves the environmental footprint of the artificial turf (in particular, this can save a high degree of material consumption, energy, and CO2 emissions). Moreover, by using recycled material for the film or the plastic granules, the production costs for the artificial turf can be reduced, because, instead of new material, recycled material (for example from old artificial turf, also referred to as “end-of-life turf”) can be reused as a secondary raw material or secondary material. Further, the use of recyclable material allows for the recycling of the artificial turf after the end of the service life and thus its re-entry into the material cycle.

The film according to the present invention preferably comprises a first layer, a second layer, and a third layer, wherein the carrier material and the first layer and the third layer are formed from substantially the same type of material, wherein the second layer comprises recycled artificial turf scrap.

For example, multi-layer films, wherein the layers comprise different types of material, can be produced using the method of multi-layer extrusion (co-extrusion). The use of substantially the same type of material for the carrier material and the first and third layer of the film improves the recyclability of the artificial turf, because no other kinds of materials, such as latex, polyurethane, etc., are included. If material is nevertheless to be processed in the artificial turf that is contaminated with other materials (e.g., sand, latex, polyurethane, or infill residues), the second layer of the film can comprise such a scrap material. This is particularly advantageous when recycled material from old artificial turf is to be reused but is contaminated with latex, for example. The soiled scrap material can thus be incorporated and stabilized between two substantially pure layers. Thus, for example, the blown film process does not result in an undesirable bursting of the hose bubble by dirt particles.

In a preferred embodiment, the material of the first layer comprises at least one of the following materials: ethylene-vinyl acetate, a thermoplastic elastomer, and a thermoplastic olefin, wherein the mass fraction of ethylene-vinyl acetate, thermoplastic elastomers and thermoplastic olefins makes up, in total, at least 50% of the mass of the first layer, preferably at least 60%, 70% or 80%, more preferably at least 90%, or at least 95%.

For example, the first layer or the material of the first layer can be provided in regions between connected regions of the fibers, on the bottom of the carrier material.

For example, the second and/or the third layer or the material of the said layer/layers can be provided in regions between connected regions of the fibers, on the bottom of the carrier material.

The first layer can have a thickness of 1 mm or less, 0.5 mm or less, 0.2 mm or less, or 0.1 mm or less. A thin first layer may be preferred with a view to efficient use of resources. A thicker first layer may enable better mechanical stability.

In a preferred embodiment, the material of the second layer and/or of the third layer comprises at least one of the following materials: ethylene-vinyl acetate, a thermoplastic elastomer, and a thermoplastic olefin, wherein the mass fraction of ethylene-vinyl acetate, thermoplastic elastomers and thermoplastic olefins makes up, in total, at least 50% of the mass of the first layer, preferably at least 60%, 70% or 80%, more preferably at least 90%, or at least 95%.

In a preferred embodiment, the method for producing an artificial turf comprises producing a first and a second artificial turf sheet according to a method of the present disclosure, providing a non-woven fabric sheet, applying a liquid adhesive to the non-woven fabric sheet, connecting the first and second artificial turf sheet to a non-woven fabric in such a way that the first and second artificial turf sheet rest on the non-woven fabric and are flush with one another.

In particular in the case of artificial turf which contains EOL turf, adhesively bonding individual sheets with one another can be difficult, since conventional adhesives, such as polyurethane adhesive (PU adhesive) do not have good adhesion properties on an artificial turf of this kind. The non-woven fabric can for example have a function as an adhesion agent, for example for the adhesive on the respective artificial turf sheets.

A method that comprises the steps of providing a non-woven fabric sheet, applying a liquid adhesive to the non-woven fabric sheet, connecting the first and second artificial turf sheet to the non-woven fabric in such a way that the first and second artificial turf sheet rest on the non-woven fabric and are flush with one another is not limited to an artificial turf and a method according to the present disclosure, but rather can be used for all types of artificial turf and/or carpets, and methods for the production thereof.

The adhesive can for example be a PU adhesive. The non-woven fabric can for example contain polyethylene terephthalate (PET), polypropylene (PP). The non-woven fabric can be a BICO non-woven fabric which contains for example PET and polyethylene (PE), or a BICO non-woven fabric which contains for example PET and PP. The non-woven fabric can have a side length that corresponds to a side length of the first and second artificial turf sheet, and a width of 40 cm or more, or 30 cm or more. For example, the first and second artificial turf sheet can rest on the non-woven fabric sheet in such a way that they are flush with one another in a central region of the non-woven fabric sheet. An edge region of a side edge of the first and/or the second artificial turf sheet can rest entirely on the non-woven fabric, i.e., the non-woven fabric can quasi function as a seam binding.

The non-woven fabric can for example have a basis weight in a range of 20-120 g/cm², preferably in a range of 30-70 g/cm².

In a preferred embodiment, the method according to the invention comprises a step of providing a film and a step of providing the non-woven fabric, wherein, in the step of feeding the carrier material, the film and the non-woven fabric are fed between the bottom of the carrier material with the connected regions of the fibers and the heated rotating calender roller, and wherein, in the step of transferring heat, the film and the non-woven fabric is fused to the bottom of the carrier material and to the connected regions of the fibers.

In the step of transferring heat, the material of the heated film can diffuse into the non-woven fabric. By means of the non-woven fabric, a form-fitting connection can be established.

The film and the non-woven fabric can for example be fed as two separate sheets. The non-woven fabric can for example be fed after feeding the film.

The film can for example also already be coated with the non-woven fabric prior to the step of feeding the carrier material, and/or the non-woven fabric can already be laminated onto the film, and the film and the non-woven fabric can be fed as a film/non-woven fabric composite.

According to one aspect of the present invention, the film can comprise a first layer, a second layer, and a third layer, wherein the first layer comprises a material having modified adhesion properties, wherein the carrier material and the third layer are formed from substantially the same material, and wherein the second layer comprises recycled artificial turf scrap. The material having modified adhesion properties can contain an adhesion agent and/or be an adhesion agent.

According to one aspect of the present invention, the film can comprise a first layer, a second layer, and a third layer, wherein the first layer comprises an adhesion agent, wherein the carrier material and the third layer are formed from substantially the same material, and wherein the second layer comprises recycled artificial turf scrap.

The use of a material having modified adhesion properties in the first layer, which faces the bottom of the carrier material, increases the adhesive force between the first layer and the carrier material, and between the first layer and the connected regions of the fibers, and furthermore improves the pull-out strength of the fibers. The fact that the same type of material is used for the carrier material and the third layer of the film makes it possible to improve the recyclability of the artificial turf, because no other kinds of materials, such as latex, polyurethane, etc., are included therein. Thus, the environmental footprint of the artificial turf can also be improved (in particular, this can save a high degree of material consumption, energy, and CO2 emissions). If material is nevertheless to be processed in the artificial turf that is contaminated with other materials (e.g., sand, latex, polyurethane, or infill residues), the second layer of the film can comprise such a scrap material. This is particularly advantageous when recycled material from old artificial turf is to be reused but is contaminated with latex, for example. The soiled scrap material can thus be incorporated and stabilized between two substantially pure layers. Thus, for example, the blown film process does not result in an undesirable bursting of the hose bubble by dirt particles.

According to a further aspect, the method for producing an artificial turf according to the present invention further comprises perforating the artificial turf and/or the coated artificial turf.

Making a perforation results in the required properties of water permeability of the artificial turf during operation.

Furthermore, an artificial turf according to the present invention is proposed, comprising: a carrier material having a top and a bottom, a plurality of fibers, wherein each fiber comprises two ends extending from the top of the carrier material and comprises a connected region arranged in a loop-like manner at the bottom of the carrier material, wherein the carrier material is fused at the bottom to the connected regions of the fibers, and wherein a bottom of the artificial turf contains an embossing in which a recessed region is formed.

The artificial turf can be of a high quality and have good heat resistance.

In the case of the artificial turf, according to the invention, the cohesion between the fibers and the carrier material is achieved in that the fibers are fused directly with the carrier material, at the connected regions. In this way, in particular a simple design of the artificial turf is ensured, and no additional film is required in order to connect the fibers to the carrier material, and the artificial turf can be produced with low material consumption. The artificial turf according to the invention is characterized in particular by a simple design with a comparable pull-out strength. Furthermore, as a result the recyclability of the artificial turf can be increased since the artificial turf contains fewer individual components of different types of material.

Preferably, the artificial turf further comprises a film, wherein the film is fused to the bottom of the carrier material and to the connected regions of the fibers.

Locally, the film is fused both to the bottom of the carrier material and also to the connected regions of the fibers, and thus strengthens the connection between the carrier material and fibers, and thus the pull-out strength of the fibers. Globally, i.e., viewed over the entire artificial turf, the film provides the artificial turf with additional stability.

In a preferred embodiment, the film comprises a first layer, a second layer, and a third layer, wherein the carrier material and the first layer and the third layer are formed from substantially the same material, wherein the second layer comprises recycled artificial turf scrap.

The use of substantially the same type of material for the carrier material and the first and third layer of the film improves the recyclability of the artificial turf, because as a result the majority of the artificial turf consists of the same type of material, and few or no other kinds of materials, such as latex, polyurethane, etc., are included. If material is nevertheless to be processed in the artificial turf that is contaminated with other materials (e.g., sand, latex, polyurethane, or infill residues), the second layer of the film can comprise such a scrap material. The soiled scrap material can thus be incorporated and stabilized between two substantially pure layers, i.e., non-contaminated layers. Thus, for example, the blown film process does not result in an undesirable bursting of the hose bubble by dirt particles. Thus, contaminated materials from e.g., old artificial turf (artificial turf scrap) can also be used in the artificial turf according to the invention, which, in addition to the above-described advantages, also further improves the environmental footprint of the artificial turf, sine material from older artificial turf is reused efficiently. In particular, this can save a high degree of energy, and CO2 emissions.

In an alternative preferred embodiment, the film comprises a first layer, a second layer, and a third layer, wherein the first layer comprises a material having modified adhesion properties, wherein the carrier material and the third layer are formed from substantially the same material, and wherein the second layer comprises recycled artificial turf scrap.

The use of a material having modified adhesion properties for the first layer, which faces the bottom of the carrier material, increases the adhesive force between the first layer and the carrier material, and between the first layer and the connected regions of the fibers, and furthermore improves the pull-out strength of the fibers. The fact that the same type of material is used for the carrier material and the third layer of the film makes it possible to improve the recyclability of the artificial turf, because no other kinds of materials, such as latex or polyurethane, are included therein. Thus, the environmental footprint of the artificial turf can also be improved (in particular, this can save a high degree of energy, and CO2 emissions). If material is nevertheless to be processed in the artificial turf that is contaminated with other materials (e.g., sand, latex, polyurethane, or infill residues), the second layer of the film can comprise such a scrap material. The soiled scrap material can thus be incorporated and stabilized between two substantially pure layers. Thus, for example, the blown film process does not result in an undesirable bursting of the hose bubble by dirt particles.

According to a further aspect, the artificial turf according to the present invention further comprises a coating, wherein the coating is formed by plastic granules melted onto the bottom of the artificial turf.

The melting of plastic granules onto the bottom of the artificial turf forms a preferably continuous coating. Locally, the coating is fused both to the bottom of the carrier material and also to the connected regions of the fibers, and thus strengthens the connection between the carrier material and fibers, and thus the pull-out strength of the fibers. Globally, i.e., viewed over the entire coated artificial turf, the coating resulting from melting on the plastic granules provides the coated artificial turf with additional stability. Furthermore, the properties of the coating (strength, coating thickness, etc.) can be flexibly adjusted to the requirements placed on the coated artificial turf, by the amount of plastic granules, the chemical composition of the plastic granules the amount and the duration of the heat input, and the pressure application by the calender roller or the pressure rollers.

The artificial turf according to the present invention is preferably produced according to one of the methods according to the invention that are explained in greater detail here.

Furthermore, an apparatus for producing an artificial turf by means of a method according to the above disclosure is proposed. The apparatus can comprise a heatable and rotatable calender roller, means for providing a carrier material having a top and a bottom, means for providing a plurality of fibers, wherein each fiber comprises two ends extending from the top of the carrier material and comprises a connected region arranged in a loop-like manner at the bottom of the carrier material, means for feeding the carrier material with the fibers to the calender roller, means for guiding the carrier material with the fibers over at least one sub-region of the surface of the calender roller, wherein the connected regions of the fibers and the bottom of the carrier material face the calender roller, means for transferring heat from the calender roller to the carrier material with the fibers during the guiding of the carrier material with the fibers over the at least one sub-region of the surface of the calender roller, means for fusing the connected regions of the fibers to the bottom of the carrier material to form the artificial turf during the guiding of the carrier material with the fibers over the at least one sub-region of the surface of the calender roller, means for embossing a bottom of the artificial turf, wherein the embossing forms a recessed region of the bottom of the artificial turf, and means for removing and cooling the artificial turf.

The apparatus can be suitable for producing an artificial turf according to the present disclosure.

### BRIEF DESCRIPTION OF THE DRAWINGS

The invention will be explained in the following on the basis of embodiments shown in the accompanying figures, in which:

FIG. 1 shows a schematic side view of an apparatus for carrying out the method for producing an artificial turf according to an embodiment of the present invention;

FIG. 2A shows an enlarged, schematic side view of a calender roller and a plurality of pressure rollers of the apparatus of FIG. 1, while carrying out a method according to the invention for producing an artificial turf, according to an embodiment of the invention;

FIG. 2B shows an enlarged, schematic side view of a calender roller and a plurality of pressure rollers, while carrying out a method according to the invention for producing an artificial turf, according to an embodiment of the invention;

FIG. 2C shows an enlarged, schematic side view of a calender roller and a plurality of pressure rollers, while carrying out a method according to the invention for producing an artificial turf, according to an embodiment of the invention;

FIG. 3 shows a schematic side view of a detail of an artificial turf that is produced by a method according to the invention;

FIG. 4A shows a schematic view from below of an artificial turf that is produced by a method according to the invention;

FIG. 4B shows a schematic view from below of an artificial turf that is produced by a method according to the invention;

FIG. 4C shows schematic cross-sections of the artificial turf from FIG. 4B along the line B;

FIG. 5A shows a view from below of a detail of a tufted carrier material used for producing an artificial turf with the method according to the invention;

FIG. 5B shows a view from below of a detail of an artificial turf that can be produced by a method according to the invention, before embossing according to the invention;

FIG. 5C shows a schematic view of an artificial turf that can be produced by a method according to the invention, before embossing according to the invention, viewed from a bottom;

FIG. 5D shows a schematic view of an artificial turf that is produced by a method according to the invention, viewed from a bottom;

FIG. 5E shows a schematic view of an artificial turf that is produced by a method according to the invention, viewed from a bottom;

FIG. 5F shows schematic cross-sections of the artificial turf from FIG. 5E along the line B′;

FIG. 5G shows a view of a bottom of an artificial turf that was produced by a method according to the invention;

FIG. 6 shows a schematic side view of an apparatus for carrying out the method for producing an artificial turf according to a further embodiment of the present invention;

FIG. 7 shows a schematic detailed view of an artificial turf according to an embodiment of the present invention;

FIG. 8 shows a schematic side view of an apparatus for carrying out the method for producing an artificial turf according to a further embodiment of the present invention;

FIG. 9 shows a schematic side view of a detail of an artificial turf that is produced by a method according to the invention.

### DETAILED DESCRIPTION

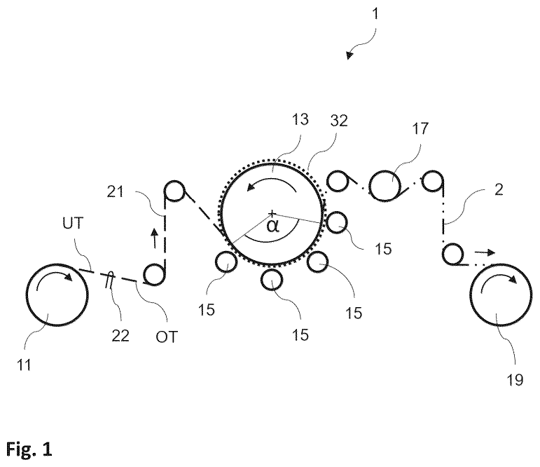

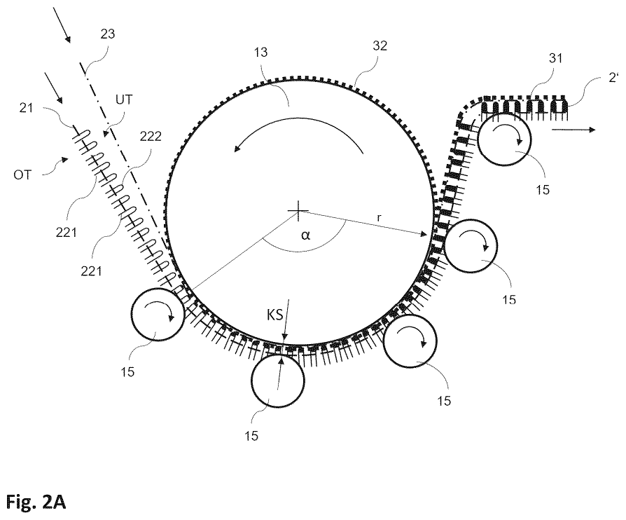

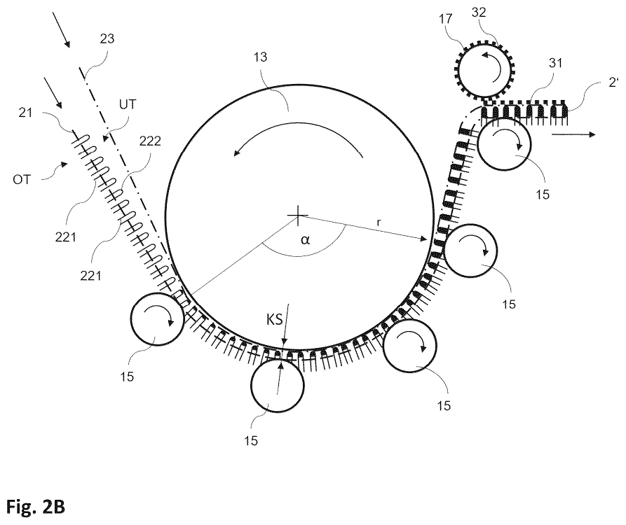

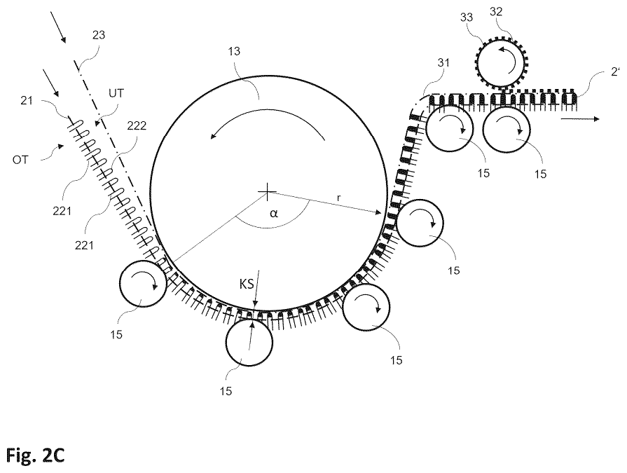

As an example embodiment, an apparatus 1 shown in FIG. 1 comprises a magazine roller 11 for a carrier material 21, a plurality of diverter rollers, a calender roller 13, a plurality of pressure rollers 15, at least one cooling roller 17, and a magazine roller 19 for artificial turf 2. In this disclosure, the carrier material 21 is shown by a dashed line and the artificial turf 2, 2′, 2″ by a dot-dash line with two dots. In FIGS. 2A-2C and 6-9, a film 23 is shown by a dot-dash line with one dot

The carrier material 21 is provided on the magazine roller 11. Preferably, the carrier material 21 comprises a fabric structure composed of, for example, PE and/or PP (known as PE and/or PP support ribbons of the slit film type), which are permeable to, for example, rainwater. Likewise, the carrier material 21 can be a fabric structure composed of co-extruded monofilaments and ribbons so as to be able to advantageously combine materials having different melting points. The carrier material 21 comprises a top OT and a bottom UT, and is provided with a plurality of fibers 22. For reasons of illustration, only one fiber 22 is shown by way of example in FIG. 1. As shown in FIGS. 2A-2C, each fiber 22 comprises two free ends 221 extending from the top OT of the carrier material 21 and comprises a connected region 222 arranged in a loop-like manner at the bottom UT of the carrier material 21.

In other words, the fibers 22 are initially loosely inserted into the carrier material 21 with the free ends 221. This arrangement of at least one fiber 22 in the carrier material 21 is referred to as tuft. In this case, the fibers 22 can be arranged on the carrier material 21 either individually or in bundles and according to a certain pattern or without a pattern. A carrier material 21 provided with a plurality of fibers 22 in this manner is also referred to as a tufted carrier material 21.

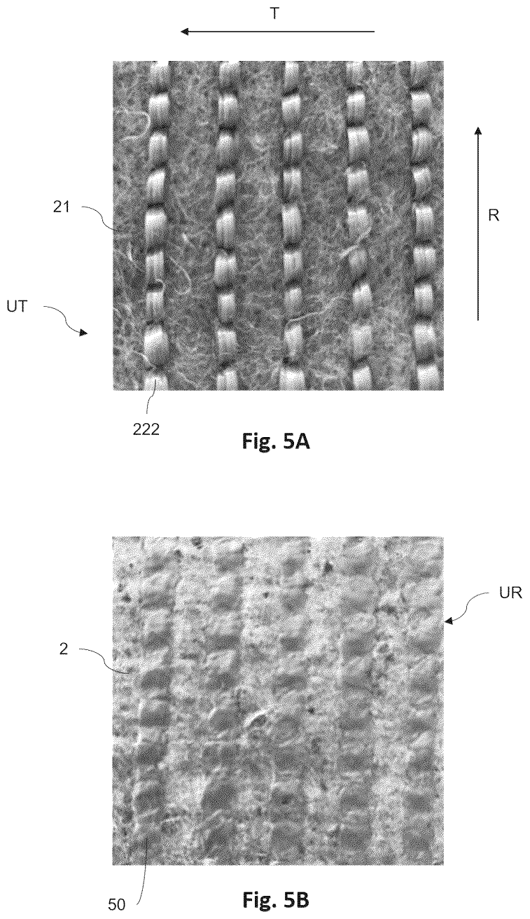

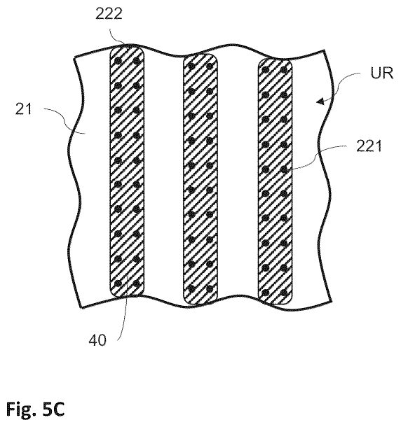

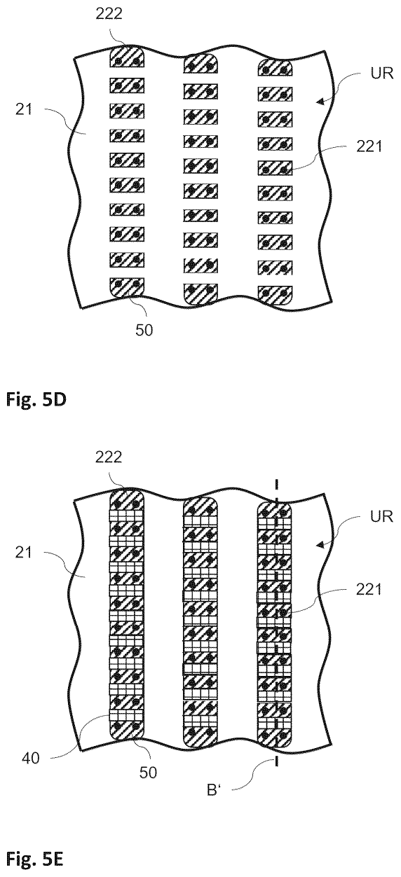

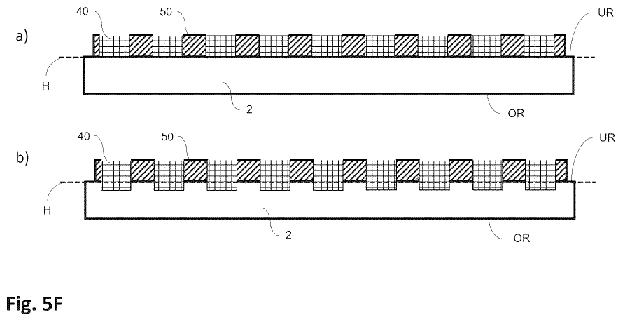

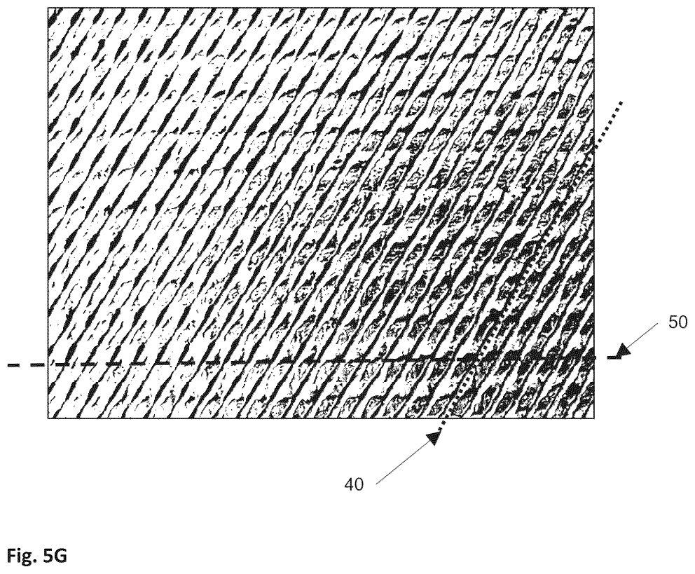

In FIG. 5A, a detail of a tufted carrier material 21 is shown from below. In this case, the fibers 22 are arranged in bundles and in rows on the carrier material 21. The vertical arrow R indicates a row direction of the tufted rows, and the horizontal arrow T indicates a splitting direction that is substantially orthogonal to the row direction. In this case, the discernible connected regions 222 of the fibers (also called fiber loops) are not yet firmly connected to one another and to the carrier material 21 (also called the backing). The row direction can be the longitudinal direction, e.g., in the direction in which the artificial turf is unrolled and/or in which the carrier material, with the fibers, is guided over the calender roller.

From the magazine roller 11, the tufted carrier material 21 is unrolled and guided via diverter rollers towards the calender roller 13, which is represented by an arrow along the carrier material 21 on the left-hand side in FIGS. 1 and 2A-2C.

The calender roller 13 has a predetermined radius r and is rotatably driven by a motor (not shown), wherein the direction of rotation of the calender roller 13 is shown in FIGS. 1 and 2A-2C by an anticlockwise arrow. The rotation speed of the calender roller 13 is adjustable in this case. Further, the calender roller 13 is heatable (for example, via an integrated heating system, not shown), thereby allowing the surface of the calender roller 13 to be heated to a predetermined temperature.

In the embodiment shown in FIGS. 1 and 2A-2C, a plurality of pressure rollers 15 are arranged adjacent to the calender roller 13 at a predetermined, adjustable distance from the calender roller 13, hereinafter referred to as the calender gap KS. The pressure rollers 15 are arranged so as to be substantially axis-parallel with the axis of rotation of the calender roller 13 and are also rotatably supported, wherein the direction of rotation of the pressure rollers 15 is shown in FIGS. 2A-2C by arrows in the clockwise direction. The pressure rollers 15 in the described embodiment can be passive pressure rollers (not driven) as well as active pressure rollers (rotationally driven).

The tufted carrier material 21 is guided onto the rotating and heated calender roller 13. In this case, the bottom UT of the carrier material 21 and the connected regions 222 of the fibers 22 face the surface of the calender roller 13, and the top OT of the carrier material 21 and free ends 221 of the fibers 22 face away from the surface of the calender roller 13. The carrier material 21 is guided between the surface of the calender roller 13 and the pressure rollers 15. In this case, the pressure rollers 15 can exert a pressure on the carrier material 21 and the fibers 22, which can be altered by an adjustment of the calender gap CG.

As shown in FIGS. 1 and 2A-2C, the tufted carrier material 21 is guided over a predetermined sub-region of the lateral surface of the calender roller 13, which is defined by the angle α. In other words, the carrier material 21 with the plurality of fibers 22 comes into contact with the surface of the calender roller 13 in a predetermined lateral surface segment defined by the angle α. This angle α can be altered by adjusting the arrangement of the diverter rollers relative to the calender roller 13.

While the tufted carrier material 21 is passed over the calender roller 13, the calender roller 13 transfers heat to the bottom UT of the carrier material 21 and to the connected regions 222 of the fibers 22 in order to fuse them together. The strength of the connection between the fibers 22 and the carrier material 21 is substantially influenced by the temperature of the calender roller 13, the rotational speed of the calender roller 13, the angle α, and the pressure exerted by the pressure rollers 15 on the carrier material 21 and the fibers 22. The temperature at the surface of the calender roller 13 is set greater than or equal to the melting temperatures of the carrier material 21 and the fibers 22, so that the connected regions of the fibers 22 are fused to the bottom UT of the carrier material 21 and form the artificial turf 2. The rotational speed of the calender roller 13, along with the radius r and the angle α, substantially determines the dwell time. The dwell time is the time in which the tufted carrier material 21 remains in contact with the calender roller 13 and can receive thermal energy from the calender roller 13.

As the dwell time of the tufted carrier material 21 on the calender roller 13 progresses, there is an increasing melting connection between the carrier material 21 and the connected regions 222 of the fibers 22. In this case, a longer dwell time of the tufted carrier material 21 on the calender roller 13 results in a higher strength of the melting connection, which is shown in FIGS. 2A-2C by the increasingly large fused region (black region at the bottom UT of the tufted carrier material 21). The pressure from the pressure rollers 15 against the tufted carrier material 21 towards the calender roller also influences the strength and quality of the connection between the fibers 22 and the carrier material 21. A higher contact pressure can accelerate the fusion between fibers 22 and carrier material 21 and strengthen the connection between fibers 22 and carrier material 21. In addition, the pressure force provided by the pressure rollers 15 pushes air out of the connection between the carrier material 21 and fibers 22. The aforementioned process parameters are preferably set such that the melting connection between the connected regions 222 and the carrier material 21 is formed in full upon the removal of the artificial turf 2 from the calender roller 13.

The bottom UT of a carrier material 21, in which the connected regions 222 of the fibers 22 are fused to the carrier material 21 and thus form the artificial turf 2, is shown in FIG. 5B, in which the artificial turf is not yet embossed. It should be noted that, in the artificial turf shown in FIG. 5B which is produced by the method according to the invention and is not yet embossed, rows have formed due to the fusion, in that adjacent fibers have fused together. This also has a positive effect on the pull-out strength.

FIG. 5C shows a schematic sectional view of the artificial turf 2 of FIG. 5B. The rows formed by the fusion of the fibers 22 with the carrier material 21 are shown shaded. In this sectional view, the exposed ends 221 are shown as black dots. The rows are raised regions 40. The rows contain fused regions.

The calender roller 13 contains an embossing unit 32, by means of which a bottom of the artificial turf is embossed. The embossed bottom can be denoted by reference sign 31. The embossing forms one or more recessed regions 40 on the bottom of the artificial turf. The embossing unit 32 does not have to be contained in the calender roller, and can for example also be contained at another point of the apparatus 1.

Different arrangements of the embossing unit 32 in the apparatus 1 are illustrated in FIGS. 2A-2C, which are explained below.

In the apparatus shown in FIGS. 1 and FIG. 2A, the step of embossing a bottom of the artificial turf takes place during the step of fusing the connected regions of the fibers with the bottom of the carrier material, to form the artificial turf.

The step of embossing a bottom of the artificial turf can also take place after the step of fusing the connected regions of the fibers with the bottom of the carrier material, to form the artificial turf.

After the connected regions 222 of the fibers 22 are fused to the bottom UT of the carrier material 21, the artificial turf 2 is fed away from the calender roller 13 and cooled. As shown in FIG. 1, the artificial turf 2 can be cooled by guiding the artificial turf 2 over a rotating cooling roller 17. In this case, the cooling roller 17 can either be passively cooling (e.g., room temperature or above) or actively cooling, wherein the actively cooled cooling roller 17 is cooled to a predetermined temperature below room temperature via a cooling assembly (not shown). The cooled artificial turf 2 is then fed away from the cooling roller 17 and rolled up on a magazine roller 19 for artificial turf 2 and magazined.

As shown in FIG. 2B, the cooling roller 17 can contain an embossing unit 32, and the bottom of the artificial turf can be embossed by means of the cooling roller 17. Here, the step of embossing a bottom of the artificial turf takes place after the step of fusing the connected regions of the fibers with the bottom of the carrier material, to form the artificial turf.

As shown in FIG. 2C, the apparatus 1 can contain an embossing roller 33 which contains an embossing unit 32, and the bottom of the artificial turf can be embossed by means of the embossing roller 33. Here, the step of embossing a bottom of the artificial turf takes place after the step of fusing the connected regions of the fibers with the bottom of the carrier material, to form the artificial turf.

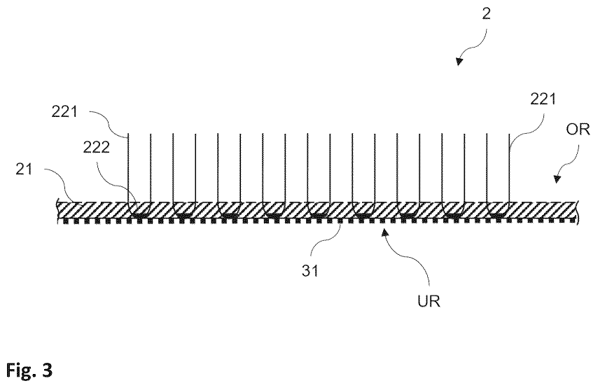

FIG. 3 shows a schematic sectional side view of the artificial turf 2 according to one embodiment of the present invention. The artificial turf 2 according to the invention comprises a carrier material 21 and a plurality of fibers 22 tufted therein. The fibers 22 comprise two exposed ends 221 extending from a top OR of the artificial turf 2, as well as a connected region 222 arranged in a loop-like manner at a bottom UT of the artificial turf 2. At this connected region 222, the fibers 22 are connected to the carrier material 21 via a melting connection, which is represented by a dark region in FIG. 3. The carrier material 21 and the fibers 22 can be formed from substantially the same material and can consist for example PE or PP. The selection of the same materials reduces the number of different materials used in the artificial turf 2, which has a positive effect on recyclability and environmental friendliness. The bottom UR of the artificial turf 2 contains an embossing 31 in which a recessed region is formed.

The top OR of the artificial turf 2 can correspond to the top OT of the carrier material 21. The bottom UR of the artificial turf 2 can correspond to the bottom UT of the carrier material 21.

The artificial turf 2 can further comprise a film 23 (not shown in FIG. 3), which can be arranged on the entire bottom UT of the carrier material 21. The film 23 can be connected to the bottom UT of the carrier material 21 as well as to the connected regions 222 of the fibers 22. This can on the one hand strengthen the connection between the fibers 22 and the carrier material 21, which is often measured by pull-out strength in practice. On the other hand, this can increase the stability of the entire artificial turf 2.

The film 23 can be a single-layer film (also known as a monofilm). The film 23 can be formed from substantially the same material as the carrier material 21. The selection of the same materials for the carrier material 21 and the film 23 also reduces the number of different materials used in the artificial turf, which likewise has a positive effect on recyclability and environmental friendliness. Moreover, the film 23 may consist of recycled material, such as artificial turf scrap from old artificial turf. This enables the implementation of a closed scrap loop and a reduction of CO2 emissions of the produced artificial turf.

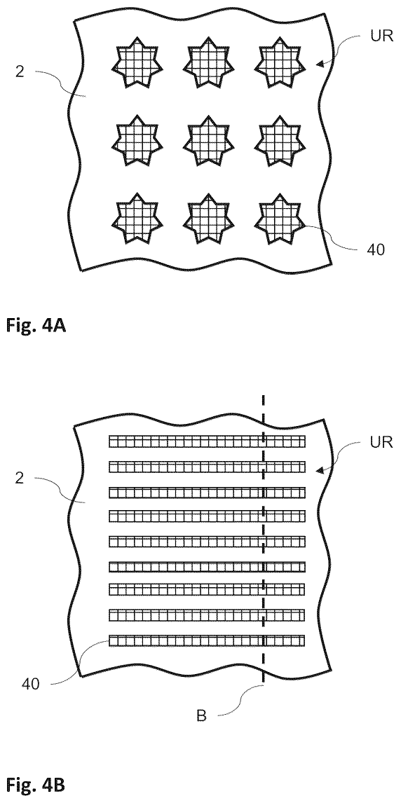

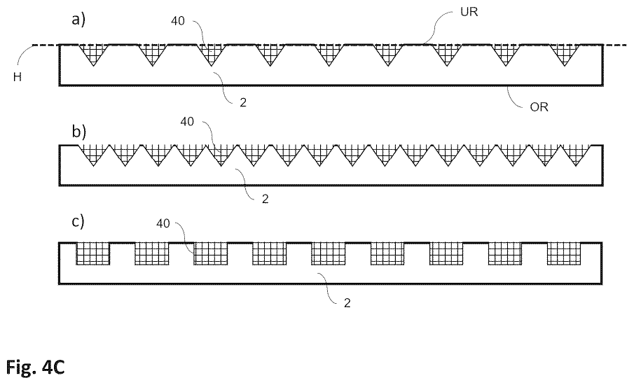

FIGS. 4A-4C and 5C-5F additionally show recessed regions 40 and raised regions 50 with corresponding shading/patterns.

FIG. 4A shows a schematic view from below of an artificial turf 2 that is produced by a method according to the invention. The bottom UR of the artificial turf 2 contains a plurality of recessed regions 40, which may be star-shaped. The recessed regions 40 can for example also be in the shape of polygons.

FIG. 4B shows a schematic view from below of an artificial turf 2 that is produced by a method according to the invention. The bottom UR of the artificial turf 2 contains a plurality of recessed regions 40, which may be groove-shaped.

FIG. 4C shows three possible schematic cross-sections a)-c) of the artificial turf from FIG. 4B along the line B from FIG. 4B. For reasons of clarity, the reference signs H, UR, and OR are set out again in b) and c)-for this, reference is made to a).

In cross-section a) the recessed regions 40 all have a triangular cross section. The recessed regions 40 can for example also be pyramid-shaped. In cross-section b) the recessed regions 40 all have a sawtooth-shaped cross section. This may also be a single recessed region 40, that is to say that the triangles in cross-section b) are interconnected, or a plurality of recessed regions 40, that is to say that the triangles in b) are not interconnected. In cross-section c) the recessed regions have a rectangular cross section. The bottom UR of the artificial turf has a main plane H which is indicated by a dashed line.

As illustrated by FIGS. 4A-4C, the shape of the recessed regions 40 can be based on the shape of the embossing unit 32.

FIG. 5A shows a view from below of a detail of a tufted carrier material which can be used for producing an artificial turf with the method according to the invention. In this case, the fibers 22 are arranged in bundles and in rows on the carrier material 21. The vertical arrow R indicates a row direction of the tufted rows, and the horizontal arrow T indicates a splitting direction that is substantially orthogonal to the row direction. In this case, the discernible connected regions 222 of the fibers (also called fiber loops) are not yet firmly connected to one another and to the carrier material 21 (also called the backing).

FIG. 5B shows a view from below of a detail of an artificial turf that can be produced by a method according to the invention, before embossing according to the invention. The bottom UT of a carrier material 21, in which the connected regions 222 of the fibers 22 are fused to the carrier material 21 and thus form the artificial turf 2, is shown. The artificial turf is not yet embossed. Rows have formed due to the fusion, in that adjacent bundles of fibers have fused together. The rows are raised regions 50. The rows contain fused regions.

FIG. 5C shows a sectional view of the artificial turf 2 of FIG. 5B before embossing according to the invention, viewed from a bottom. The rows formed by the fusion of the fibers 22 with the carrier material 21 are shown shaded. The rows correspond here to raised regions 40. In this sectional view, the exposed ends 221 are shown as black dots.

FIG. 5D shows a schematic view from below of the artificial turf from FIG. 5C, after an embossing step according to the invention. The recessed regions 40 are not denoted. It is clear from a comparison with FIG. 5C that the embossing has interrupted the fused regions, i.e., the rows or the raised regions 50.

FIG. 5E shows a schematic view from below of the artificial turf from FIG. 5, after an embossing step according to the invention. The recessed regions 40 reduce the height of the raised regions 50 in portions. Reducing the height of the raised regions 50 in portions can reduce the height by 100%, i.e., interrupt the raised regions 50, or reduce said height by more than 100%, or by less than 100%.

FIG. 5F shows schematic cross-sections of the artificial turf from FIG. 5E along the line B′. In cross-section a) the height of the raised region 50 is reduced in portions by 100%, i.e., interrupted. In cross-section b) the height is reduced in portions by more than 100%. H denotes the main plane of the bottom UR of the artificial turf 2, which is indicated by a dashed line. OR denotes the top of the artificial turf 2.

FIG. 5G shows a view of a bottom of an artificial turf that was produced by a method according to the invention. The recessed regions are in the shape of slanted grooves. Raised regions extend, in the form of rows, from left to right of FIG. 5G. For clarification, one of the recessed regions 40 is indicated by a dotted line, and one of the raised regions 50, which is interrupted by the recessed regions 40, is indicated by a dashed line.

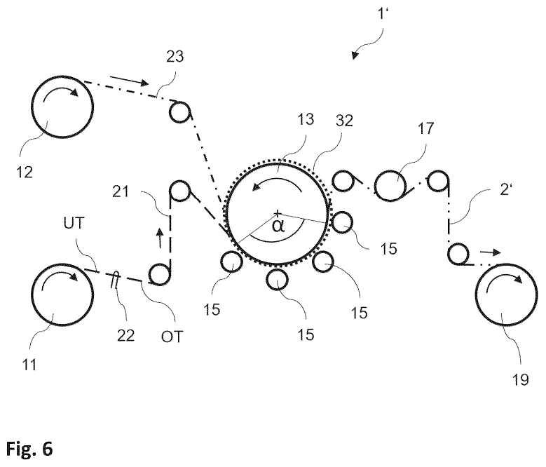

FIG. 6 shows a schematic side view of an apparatus 1′ for carrying out the method for producing an artificial turf 2′ according to a further embodiment of the present invention. In the embodiment shown, the apparatus 1′ comprises a magazine roller 11 for carrier material 21, a magazine roller 12 for a film 23, a plurality of diverter rollers, a calender roller 13, a plurality of pressure rollers 15, at least one cooling roller 17, and a magazine roller 19 for artificial turf 2′. The steps of providing a carrier material 21, providing a plurality of fibers 22 and feeding the carrier material 21 with the fibers 22 to a heated rotating calender roller 13 are substantially identical to the embodiment described above, which is shown in FIGS. 1 and 2A, and therefore repeated description of these steps is omitted.

As shown in FIG. 6, in addition to the tufted carrier material 21, a film 23 is unrolled from the magazine roller 12 and fed to the heated rotating calender roller 13 via diverter rollers, which is shown by an arrow on the left-hand side in FIG. 6.

In this case, the film 23 is guided on the bottom of the tufted carrier material 21. The bottom UT of the carrier material 21 and the connected regions 222 of the fibers 22 face the surface of the calender roller 13, the top OT of the carrier material 21 and free ends 221 of the fibers 22 face away from the surface of the calender roller 13, and the film 23 is located between the bottom UT of the tufted carrier material 21 and the calender roller 13. The carrier material 21 and the film 23 are guided between the surface of the calender roller 13 and the pressure rollers 15. In this case, the pressure rollers 15 can exert a pressure on the tufted carrier material 21 and the film 23, which can be altered by an adjustment of the calender gap CG. As shown in FIG. 6, the tufted carrier material 21 and the film 23 is guided over a predetermined sub-region of the lateral surface of the calender roller 13, which is defined by the angle α. In other words, the carrier material 21 with the plurality of fibers 22 and the film 23 comes into contact with the surface of the calender roller 13 in a predetermined lateral surface segment defined by the angle α. This angle α can be altered by adjusting the arrangement of the diverter rollers relative to the calender roller 13.

While the tufted carrier material 21 and the film 23 are passed over the calender roller 13, the calender roller 13 transfers heat to the film 23, the bottom UT of the carrier material 21 and to the connected regions 222 of the fibers 22 in order to fuse them together. The temperature at the surface of the calender roller 13 is set greater than or equal to the melting temperatures of the film 23, the carrier material 21 and the fibers 22. As a result, the connected regions of the fibers 22 are fused to the bottom UT of the carrier material 21. In addition, in the embodiment that is shown in FIG. 6, the film 23 is also fused to the bottom UT of the carrier material 21 as well as to the connected regions of the fibers 22. As the dwell time of the tufted carrier material 21 and the film 23 on the calender roller 13 progresses, there is an increasing melting connection between the carrier material 21, the connected regions 222 of the fibers 22, and the film 23, as a result of which the artificial turf 2′ is formed. In this case, a longer dwell time of the tufted carrier material 21 and the film 23 on the calender roller 13 results in a higher strength and quality of the melting connection, which is shown in FIGS. 2A-2C by the increasingly large fused region (black region at the bottom UT of the tufted carrier material 21). A higher contact pressure can accelerate the fusion between the fibers 22, the carrier material 21 and the film 23, and strengthen the connection between the fibers 22, the carrier material 21 and the film 23. In addition, the pressure force provided by the pressure rollers 15 pushes air out of the connection between the carrier material 21, the fibers 22 and the film 23. The aforementioned process parameters are preferably set such that the melting connection between the connected regions 222, the carrier material 21 and the film 23 is formed in full upon the removal of the artificial turf 2′ from the calender roller 13.

The aforementioned process parameters are preferably set such that the melting connection between the connected regions 222, the carrier material 21 and the film 23 is formed in full upon the removal of the artificial turf 2′ from the calender roller 13. In addition to the above-described process parameters, the film 23 influences the strength of the connection between the fibers 22 and the carrier material 21. Because the film 23 locally connects to the carrier material 21 as well as the connected regions 222 of fibers 22, the connection between the carrier material 21 and the fibers 22 is strengthened, and the pull-out strength of the fibers 22 is increased. In addition, the film 23 globally connects with the entire carrier material 21, thereby also increasing the stability of the carrier material 21.

After the connected regions 222 of the fibers 22, the bottom UT of the carrier material 21, and the film 23 are fused, the artificial turf 2′ is fed away from the calender roller 13 and cooled. The process of cooling the artificial turf 2′ and rolling up and magazining the artificial turf 2′ on a magazine roller 19 is analogous to the embodiment shown with reference to FIG. 1.

The calender roller 13 contains an embossing unit 32, by means of which a bottom of the artificial turf is embossed. The embossing forms one or more recessed regions 40 on the bottom of the artificial turf. The embossing unit 32 does not have to be contained in the calender roller, and can for example also be contained at another point of the apparatus 1. Different arrangements of the embossing unit 32 in the apparatus 1 are illustrated in FIGS. 2A-2C, the disclosure of which is also applicable to the apparatus 1′.

The step of embossing a bottom of the artificial turf can take place during the step of fusing the connected regions of the fibers with the bottom of the carrier material, to form the artificial turf, for example when the calender roller 13 contains the embossing unit 32.

The step of embossing a bottom of the artificial turf can take place after the step of fusing the connected regions of the fibers with the bottom of the carrier material, to form the artificial turf, for example when the calender roller 13 does not contain the embossing unit 32, i.e., the embossing unit 32 is separate from the calender roller 13.

The step of embossing a bottom of the artificial turf can take place during the step of fusing the bottom of the artificial turf to the film, to form a coated artificial turf, for example when the calender roller 13 contains the embossing unit 32.

The step of embossing a bottom of the artificial turf can take place after or before the step of fusing the bottom of the artificial turf to the film, to form a coated artificial turf, for example when the calender roller 13 does not contain the embossing unit 32, i.e., the embossing unit 32 is separate from the calender roller 13.

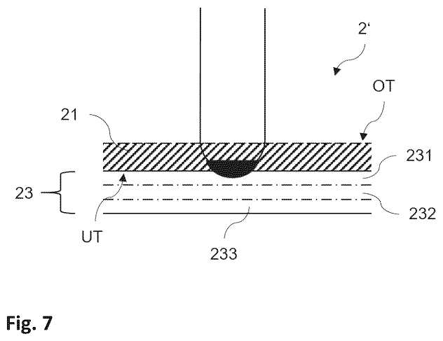

In the following, the structure of the artificial turf 2′ according to an embodiment of the present invention is described in greater detail with reference to FIG. 7.

FIG. 7 shows a schematic sectional side view of the artificial turf 2′ according to one embodiment of the present invention. The artificial turf 2′ according to the invention comprises a carrier material 21 and a plurality of fibers 22 tufted therein (just one fiber 22 is shown in FIG. 7). The fibers 22 comprise two exposed ends 221 extending from a surface OT of the carrier material 21, as well as a connected region 222 arranged in a loop-like manner at a bottom UT of the carrier material 21.

At this connected region 222, the fibers 22 are connected to the carrier material 21 via a melting connection, which is represented by a dark region in FIG. 7. The carrier material 21 and the fibers 22 can be formed from substantially the same material and can consist for example PE or PP. The selection of the same materials reduces the number of different materials used in the artificial turf 2, which has a positive effect on recyclability and environmental friendliness. As shown in FIG. 7, the artificial turf 2′ can further comprise a film 23, which is arranged on the entire bottom UT of the carrier material 21. The film 23 is connected to the bottom UT of the carrier material 21 as well as to the connected regions 222 of the fibers 22. On the one hand, this strengthens the connection between the fibers 22 and the carrier material 21, which is often measured by pull-out strength in practice. On the other hand, this increases the stability of the entire artificial turf 2′. The bottom of the artificial turf contains an embossing 31 in which a recessed region is formed (not shown in FIG. 7).

In some embodiments, the film 23 shown in FIG. 7 can be a multi-layered film. In some embodiments, the film 23 can be a single-layer film (also known as a monofilm). In some embodiments, the film 23 is attached using the method according to the invention described above, and can be formed from substantially the same material as the carrier material 21. The selection of the same materials for the carrier material 21 and the film 23 also reduces the number of different materials used in the artificial turf 2′, which likewise has a positive effect on recyclability and environmental friendliness. Moreover, the film 23 may consist of recycled material such as artificial turf scrap from old artificial turf. This enables the implementation of a closed scrap loop and a reduction of CO2 emissions of the produced artificial turf 2′.

In the detailed view of the embodiment of the artificial turf 2′ shown in FIG. 7, the film 23 is a three-layered film (also known as a co-extrusion film). In this case, the film 23 comprises a first layer 231, a second layer 232, and a third layer 233. The first layer 231 is arranged at the bottom UT of the carrier material 21. The second layer 232 is arranged on the first layer 231 and is enclosed or surrounded by the first layer 231 and the third layer 233, respectively. Such a three-layered film 23 can be produced, for example, via the co-extrusion process.

According to one embodiment of the present invention, the carrier material 21 and the third layer 233 are formed from substantially the same material, and the second layer 232 is formed from artificial turf scrap or from old artificial turf. The use of substantially the same material or type of material for the carrier material 21 and the first layer 231 and the third layer 233 increases the recyclability of the artificial turf 2′, because, in this case, few or no other materials or types of material (e.g., latex, polyurethane, etc.) are contained in the artificial turf 2′.

In order to still allow material that has been contaminated with, for example, sand, latex, polyurethane, or infill residues to be reused in the production of the artificial turf in the sense of a closed scrap loop, the second layer 232 of the film 23 can comprise such a material. This is particularly advantageous when recycled material from old artificial turf is to be reused but is contaminated with latex, for example. The soiled scrap material can thus be incorporated and stabilized between two substantially pure layers. Thus, for example, the blown film process does not result in an undesirable bursting of the hose bubble by dirt particles.

The first layer 231 shown in FIG. 7 can also be formed from a material having modified adhesion properties. In this case, on the one hand, an adhesion agent can be added to the material of the first layer 231 described above, wherein the adhesion agent can comprise, for example, maleic anhydride (MAH). On the other hand, a material with molten glue-like properties can be used, for example ethylene-vinyl acetate (EVA).

It is also conceivable that a material other than the one described above can be mixed with these adhesion agents in order to achieve the desired modified adhesion properties. The use of such materials or additives for the material of the first layer 231 improves the adhesion between the carrier material 21 and the multi-layer film 23 and the stability of the artificial turf 2′.

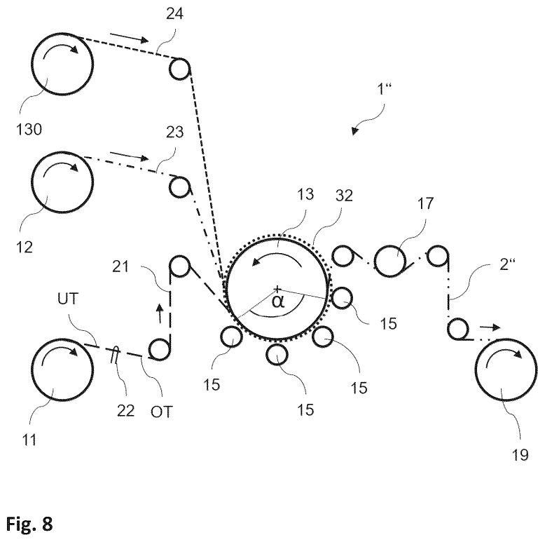

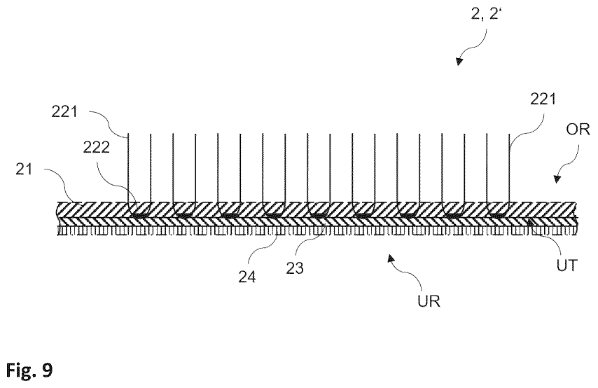

FIG. 8 shows a schematic side view of an apparatus 1″ for carrying out the method for producing an artificial turf 2″ according to a further embodiment of the present invention. Compared with the apparatus 1′ of FIG. 6, the apparatus 1″ of FIG. 8 contains a magazine roller 130 for a non-woven fabric 24.

FIG. 9 shows a schematic sectional side view of the artificial turf 2″ according to one embodiment of the present invention. The artificial turf 2″ according to the invention comprises a carrier material 21 and a plurality of fibers 22 tufted therein. The fibers 22 comprise two exposed ends 221 extending from a top OR of the artificial turf 2, as well as a connected region 222 arranged in a loop-like manner at a bottom UT of the carrier material 21. At this connected region 222, the fibers 22 are connected to the carrier material 21 via a melting connection, which is represented by a dark region in FIG. 9.

The bottom UR of the artificial turf 2″ contains an embossing 31 in which a recessed region is formed (not shown in FIG. 9). The bottom UR of the artificial turf 2″ contains a film 23 and a non-woven fabric 24.

Above, the case was considered where the carrier material, the fibers and the film each consist of plastic materials. Within the meaning of the invention, the carrier material, the fibers and the film can also consist of different materials (e.g., organic materials) from those mentioned herein.

Within the meaning of the invention, the term “artificial turf” also includes all other planar apparatuses or products which comprise one or more fiber-like protruding elements and are produced according to the invention.

Further advantageous embodiments and modifications emerge, for a person skilled in the art, from the embodiments described here, and will be understood by said person as belonging to the invention.

### LIST OF REFERENCE SIGNS

1, 1′, 1″ apparatus for producing artificial turf

2, 2′, 2″ artificial turf

11 magazine roller for carrier material

12 magazine roller for film

13 calender roller

14 further calender roller

15 pressure roller

17 cooling roller

19 magazine roller for artificial turf

21 carrier material

22 fiber

23 film

24 non-woven fabric

31 embossed bottom of the artificial turf

32 embossing unit

33 embossing roller

40 recessed region

50 raised region

130 magazine roller for non-woven fabric

221 free end of the fiber

222 connected region of the fiber

231 first layer of the film

232 second layer of the film

233 third layer of the film

H main plane

OR top of the artificial turf

OT top of the carrier material

UR bottom of the artificial turf

UT bottom of the carrier material

What is claimed is:

1. A method for producing an artificial turf, the method comprising the steps of:
providing a carrier material having a top and a bottom;
providing a plurality of fibers, wherein each fiber comprises two ends extending from the top of the carrier material, and comprises a connected region arranged in a loop-like manner at the bottom of the carrier material;
feeding the carrier material with the fibers to a heated rotating calender roller;
guiding the carrier material with the fibers over at least one sub-region of the surface of the heated rotating calender roller, wherein the connected regions of the fibers and the bottom of the carrier material face the calender roller;
during the guiding of the carrier material with the fibers over the at least one sub-region of the surface of the heated rotating calender roller:
transferring heat from the heated rotating calender roller to the carrier material with the fibers, and
fusing the connected regions of the fibers with the bottom of the carrier material, to form the artificial turf; wherein the method further comprises:
embossing a bottom of the artificial turf, wherein the embossing forms a recessed region of the bottom of the artificial turf; and
removing and cooling the artificial turf.

2. The method according to claim 1,
wherein the bottom of the artificial turf has a main plane;
wherein the main plane is a plane that contains one or more surface regions of the bottom of the artificial turf;
wherein the one or more surface regions which are contained in the main plane have a total surface area which is at least 30% of the total surface area of the bottom of the artificial turf; and
wherein the recessed region is preferably recessed relative to the main plane of the bottom of the artificial turf.

3. The method according to claim 1,
wherein the artificial turf contains a raised region on its bottom;
wherein the raised region has a height from a plane, downwards, wherein the plane contains one or more surface regions of the bottom of the artificial turf;
wherein the raised region extends in a length along a direction on the bottom of the artificial turf;
wherein the length is greater than the average distance between two adjacent fibers; and
wherein the embossing reduces the height of the raised region from the plane in portions and/or interrupts the raised region in portions.

4. The method according to claim 1,
wherein the embossing forms a plurality of recessed regions of the bottom of the artificial turf, and
wherein the recessed regions are at an average distance from one another of at most 0.5 cm, at most 1 cm, at most 2 cm, or at most 5 cm.

5. The method according to claim 1,
wherein a maximum height of shifts of the carrier material of the artificial turf on the top of the artificial turf at a predetermined temperature of the artificial turf is less than 2 cm, preferably less than 1 cm, more preferably less than 0.5 cm, even more preferably less than 0.1 cm;
wherein the height is a height of a flat surface region of the top of the carrier material of the artificial turf; and
wherein shifts include surface regions of the top of the carrier material of the artificial turf which are raised relative to a flat surface region of the top of the carrier material.

6. The method according to claim 5, wherein the predetermined temperature is at least 35° C., preferably at least 40° C., more preferably at least 50° C., even more preferably at least 60° C., even more preferably at least 70° C.

7. The method according to claim 1,
wherein the calender roller contains an embossing unit, and wherein the bottom of the artificial turf is embossed by means of the embossing unit of the calender roller.

8. The method according to claim 1,
wherein the artificial turf is cooled by means of a cooling roller;
wherein the artificial turf is fed to the cooling roller; and
wherein the cooling roller contains an embossing unit, and the bottom of the artificial turf is embossed by means of the embossing unit of the cooling roller.

9. The method according to claim 1,
wherein the method further comprises: feeding the artificial turf to an embossing roller which comprises an embossing unit, wherein the bottom of the artificial turf is embossed by means of the embossing unit of the embossing roller, and
wherein prior to the embossing heat is transferred to the artificial turf, and/or wherein the bottom of the artificial turf is embossed prior to removal and cooling of the artificial turf.

10. The method according to claim 1, further comprising:
providing a film; and
feeding the film between the bottom of the carrier material with the connected regions of the fibers and the heated rotating calender roller in the step of feeding the carrier material and fusing the film to the bottom of the carrier material and to the connected regions of the fibers in the step of transferring heat; or
feeding the film between a bottom of the artificial turf and a further heated rotating calender roller after the step of removing and cooling the artificial turf, transmitting heat from the further heated rotating calender roller to the bottom of the artificial turf and the film, fusing the bottom of the artificial turf to the film to form a coated artificial turf, and removing and cooling the coated artificial turf.

11. The method according to claim 10,
wherein the material of the film comprises at least one of:
ethylene-vinyl acetate,
a thermoplastic elastomer, or
a thermoplastic olefin.

12. The method according to claim 11, wherein a mass fraction of the ethylene-vinyl acetate, the thermoplastic elastomers, and the thermoplastic olefins makes up, in total, at least 50% of a mass of the film, preferably at least 60%, 70% or 80%, more preferably at least 90%.

13. The method according to claim 10,
wherein the film comprises a first layer, a second layer and a third layer;
wherein the carrier material and the first layer and the third layer are formed from substantially the same type of material; and
wherein the second layer comprises recycled artificial turf scrap.

14. The method according to claim 13,
wherein the material of the first layer comprises at least one of:
ethylene-vinyl acetate,
a thermoplastic elastomer, or
a thermoplastic olefin.

15. The method according to claim 14, wherein a mass fraction of the ethylene-vinyl acetate, the thermoplastic elastomers, and the thermoplastic olefins makes up, in total, at least 50% of a mass of the first layer, preferably at least 60%, 70% or 80%, more preferably at least 90%.

16. The method according to claim 1, further comprising:
producing a first and a second artificial turf sheet;
providing a non-woven fabric sheet;
applying a liquid adhesive to the non-woven fabric sheet; and
connecting the first and second artificial turf sheet to a non-woven fabric in such a way that the first and second artificial turf sheet rest on the non-woven fabric and are flush with one another.

17. The artificial turf produced by the method of claim 1.

18. An apparatus for producing the artificial turf of claim 1, the apparatus comprising:
a heatable and rotatable calender roller;
means for providing a carrier material having a top and a bottom;
means for providing a plurality of fibers, wherein each fiber comprises two ends extending from the top of the carrier material and comprises a connected region arranged in a loop-like manner at the bottom of the carrier material;
means for feeding the carrier material with the fibers to a calender roller;
means for guiding the carrier material with the fibers over at least one sub-region of the surface of the calender roller, wherein the connected regions of the fibers and the bottom of the carrier material face the calender roller;
means for transferring heat from the calender roller to the carrier material with the fibers during the guiding of the carrier material with the fibers over the at least one sub-region of the surface of the calender roller;
means for fusing the connected regions of the fibers to the bottom of the carrier material to form the artificial turf during the guiding of the carrier material with the fibers over the at least one sub-region of the surface of the calender roller;
means for embossing a bottom of the artificial turf, wherein the embossing forms a recessed region of the bottom of the artificial turf; and
means for removing and cooling the artificial turf.

19. An apparatus for producing the artificial turf of claim 1, the apparatus comprising:
a heatable and rotatable calender roller;
a magazine roller configured to provide a carrier material having a top and a bottom, wherein the carrier material comprises a plurality of fibers and wherein each fiber comprises two ends extending from the top of the carrier material and comprises a connected region arranged in a loop-like manner at the bottom of the carrier material;
diverter rollers configured to feed the carrier material with the fibers to the calender roller;
at least one pressure roller configured to guide the carrier material with the fibers over at least one sub-region of the surface of the calender roller, wherein the connected regions of the fibers and the bottom of the carrier material face the calender roller, wherein the calender roller is configured to transfer heat to the carrier material with the fibers during the guiding of the carrier material with the fibers over the at least one sub-region of the surface of the calender roller, and wherein the calender roller is configured to fuse the connected regions of the fibers to the bottom of the carrier material to form the artificial turf during the guiding of the carrier material with the fibers over the at least one sub-region of the surface of the calender roller;
an embossing unit configured to emboss a bottom of the artificial turf, wherein the embossing forms a recessed region of the bottom of the artificial turf; and
a cooling roller configured to cool the artificial turf and a magazine roller configured to remove the artificial turf.

20. Artificial turf, comprising:
a carrier material having a top and a bottom; and
a plurality of fibers, wherein each fiber comprises two ends extending from the top of the carrier material and comprises a connected region arranged in a loop-like manner at the bottom of the carrier material,
wherein the carrier material is fused at the bottom to the connected regions of the fibers, and
wherein a bottom of the artificial turf contains an embossing in which a recessed region is formed.
